(19) United States
(12) Patent Application Publication
(10) Pub. No.: US 2024/0253162 A1
(43) Pub. Date: Aug. 1, 2024

(54) ADDITIVE MANUFACTURING APPARATUS AND ADDITIVE MANUFACTURING METHOD

(71) Applicant: Mitsubishi Electric Corporation, Tokyo (JP)

(72) Inventors: Daiji MORITA, Tokyo (JP); Nobuhiro SHINOHARA, Tokyo (JP); Takashi YUZAWA, Tokyo (JP)

(73) Assignee: Mitsubishi Electric Corporation, Tokyo (JP)

(21) Appl. No.: 18/564,635

(22) PCT Filed: Jun. 3, 2021
(86) PCT No.: PCT/JP2021/021243

§ 371 Date: Nov. 28, 2023

(51) Int. Cl. B23K 26/342; B33Y 10/00; B33Y 30/00; B33Y 50/02

(52) U.S. Cl. CPC B23K 26/342; B33Y 10/00; B33Y 30/00; B33Y 50/02

(57) ABSTRACT

An additive manufacturing apparatus forming an inclined shaped object on an additive target surface of a base substrate, includes a material supply unit supplying the build material to a machining area of the additive target surface, an emission unit emitting laser beam to the machining area to melt the build material, and a control device controlling formation of the inclined shaped object by controlling the material supply unit and the emission unit. The control device causes a first inclination bead to be formed on a top surface of a lower inclination bead layer, and then causes a second inclination bead in contact with the top surface of the lower inclination bead layer and a side surface of the first inclination bead, to be formed at a position where part of the bottom surface of the second inclination bead has no contact with the lower inclination bead layer.

### FIELD

The present disclosure relates to an additive manufacturing apparatus and an additive manufacturing method for producing a three-dimensional shaped object.

### BACKGROUND

One known conventional technology for producing a three-dimensional shaped object is a technology called additive manufacturing (AM). Among several types of additive manufacturing techniques, a directed energy deposition (DED) technique is advantageous due to factors such as a shorter shaping time, simpler switching between stacking materials, and less restriction on base material than those in other techniques. In addition, the DED technique consumes material no more than the amount used for production of the shaped object, thereby resulting in a less waste of material than in other techniques. Additive manufacturing apparatuses for use in the DED technique can use both a powder and a wire as the material by changing the configuration of the machining head as appropriate. When an additive manufacturing apparatus for use in the DED technique uses a wire as the material, applicability of a ready-made welding wire allows the material procurement cost to be reduced, and the material to be readily procured.

The deposition system of Patent Literature 1 includes a material supply device, an energy source for generating a beam of weld energy having a cross-sectional area, and a metal feedstock. This deposition system deposits linear rows of the metal material on the outer surface of the structure by emitting less than 30% of the cross-sectional area of the beam of weld energy onto a currently-deposited one of the linear rows.

### CITATION LIST

### Patent Literature

Patent Literature 1: U.S. Pat. No. 9,835,114

### SUMMARY OF INVENTION

### Problem to be Solved by the Invention

However, when an inclined wall is to be formed, the technology of foregoing Patent Literature 1 allows a melted metal bead to bend downward due to action of gravity upon occurrence of a slightest deviation of the beam irradiation position, thereby causing the three-dimensional shaped object to lose the shape. This requires the technology of foregoing Patent Literature 1 to strictly control the beam irradiation position to prevent the melted metal bead from bending downward due to action of gravity. This presents a problem of difficulty in formation of an inclined wall.

The present disclosure has been made in view of the foregoing, and it is an object of the present disclosure to provide an additive manufacturing apparatus capable of easily forming an inclined wall.

### Means to Solve the Problem

To solve the problem and achieve the object described above, the present disclosure is directed to an additive manufacturing apparatus for forming an inclined shaped object on an additive target surface of a workpiece to which build material is to be added, the inclined shaped object being a shaped object inclined in an oblique direction oblique with respect to a vertical direction, the additive manufacturing apparatus including: a material supply unit to supply the build material to a machining area of the additive target surface; an emission unit to emit a laser beam to the machining area to melt the build material; and a control device to control formation of the inclined shaped object by controlling the material supply unit and the emission unit. The control device causes a lower bead layer to be stacked, and then causes an upper bead layer to be stacked, the lower bead layer being a bead layer including a first bead and a second bead that are deposited, the upper bead layer being a bead layer including a third bead and a fourth bead that are deposited on a top surface of the lower bead layer. The control device causes the upper bead layer to be stacked by causing the third bead to be formed on the top surface of the lower bead layer, and then causing the fourth bead to be formed at a position where part of a bottom surface of the fourth bead has no contact with the lower bead layer, the fourth bead being in contact with the top surface of the lower bead layer and with a side surface of the third bead.

### Effects of the Invention

An additive manufacturing apparatus according to the present disclosure is advantageous in capability of easily forming an inclined wall.

### BRIEF DESCRIPTION OF DRAWINGS

FIG. 1 is a diagram illustrating a configuration of an additive manufacturing apparatus according to a first embodiment.

FIG. 2 is a schematic diagram illustrating a machining process performed by the additive manufacturing apparatus according to the first embodiment.

FIG. 3 is a block diagram illustrating a hardware configuration of a control device included in the additive manufacturing apparatus according to the first embodiment.

FIG. 4 is a flowchart illustrating an operation procedure of the additive manufacturing apparatus according to the first embodiment.

FIG. 5 is a schematic diagram illustrating an inclined shaped object formed by the additive manufacturing apparatus according to the first embodiment.

FIG. 6 is a schematic diagram illustrating an inclined shaped object formed on an inclined base substrate by the additive manufacturing apparatus according to the first embodiment.

FIG. 7 is a diagram for describing an inclined shaped object formed by an additive manufacturing apparatus of a comparative example.

FIG. 8 is a diagram illustrating a configuration of an additive manufacturing system according to the first embodiment.

FIG. 9 is a schematic diagram illustrating an example of shaped object formed by a combination of the inclined shaped objects by the additive manufacturing apparatus according to the first embodiment.

FIG. 10 is a flowchart illustrating an operation procedure of an additive manufacturing apparatus according to a second embodiment.

FIG. 11 is a schematic diagram illustrating an inclined shaped object formed by the additive manufacturing apparatus according to the second embodiment.

FIG. 12 is a flowchart illustrating an operation procedure of an additive manufacturing apparatus according to a third embodiment.

FIG. 13 is a schematic diagram illustrating an inclined shaped object formed by the additive manufacturing apparatus according to the third embodiment.

FIG. 14 is a flowchart illustrating an operation procedure when a spherical bead is formed by an additive manufacturing apparatus according to a fourth embodiment.

FIG. 15 is a diagram for describing a method for producing a spherical bead to be produced by the additive manufacturing apparatus according to the fourth embodiment.

FIG. 16 is a schematic diagram illustrating an inclined shaped object formed by the additive manufacturing apparatus according to the fourth embodiment.

### DESCRIPTION OF EMBODIMENTS

An additive manufacturing apparatus and an additive manufacturing method according to embodiments of the present disclosure will be described in detail below with reference to the drawings.

### First Embodiment

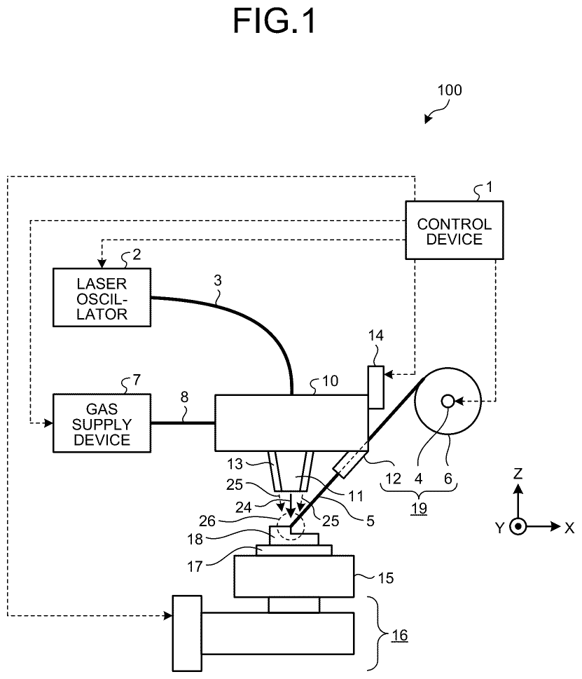

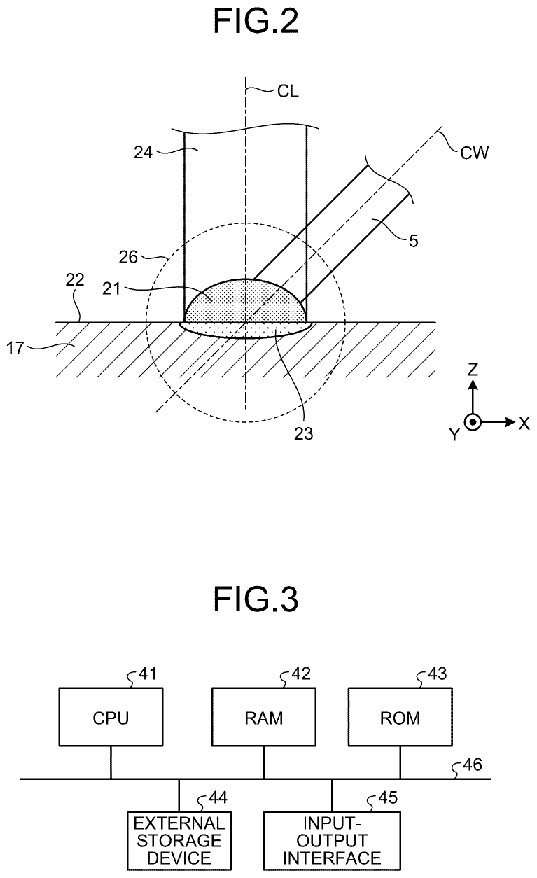

FIG. 1 is a diagram illustrating a configuration of an additive manufacturing apparatus according to a first embodiment. FIG. 2 is a schematic diagram illustrating a machining process performed by the additive manufacturing apparatus according to the first embodiment. FIG. 2 schematically illustrates a machining area 26 to be used by an additive manufacturing apparatus 100.

The additive manufacturing apparatus 100 is a machine tool that produces a three-dimensional shaped object, which is a three-dimensional object, by additive machining in which a material melted by emission of a beam is added onto an additive target surface of a workpiece. The additive manufacturing apparatus 100 forms an inclined shaped object, which is a shaped object inclined in an oblique direction oblique with respect to the vertical direction, on the additive target surface of the workpiece to which build material is added.

In the first embodiment, a laser beam 24 is the beam, and a wire 5, which is a wire-shaped metal material, is the build material. Note that the build material may be a material other than a metal. The build material may be any material having any shape that is supplied to a machining position in a form of a wire material, and is melted to allow a bead to be formed. The build material may be any material, for example, having a certain degree of rigidity to be feedable to an intended position without largely drooping down until the build material is drawn out by a certain length when the build material is drawn out with an end thereof being held. Examples of the shape of the wire 5 include shapes having a small protrusion in a direction perpendicular to the length of the wire, such as a shape of a strand of two wires, and a non-circular cross-sectional shape. In addition, the build material may have a shape other than a wire shape. The build material may also be, for example, a metal in powder form or a resin in powder form.

The additive manufacturing apparatus 100 deposits multiple beads on a base substrate 17 to form a deposit 18 formed of the metal material on a surface of the base substrate 17. Each of the beads is an object formed by solidification of the wire 5 that was melted, and is the deposit 18. The base substrate 17 is placed on a stage 15. The workpiece is an object to which a melted material is added, and refers to the base substrate 17 or to the deposit 18. The shaped object is the deposit 18 that has been produced by addition of the material according to a machining program. The base substrate 17 illustrated in FIG. 1 is a plate material. The base substrate 17 may be other than a plate material.

The additive manufacturing apparatus 100 includes a machining head 10, which is moved relative to the workpiece. The machining head 10 includes a beam nozzle 11, a wire nozzle 12, and a gas nozzle 13. The beam nozzle 11 emits a laser beam 24 toward the workpiece. The laser beam 24 is a heat source for melting the wire 5. The wire nozzle 12 moves the wire 5 forward to the position of irradiation of the laser beam 24 on the workpiece. The gas nozzle 13 jets, to the workpiece, shielding gas for preventing oxidation of the deposit 18 and for cooling beads such as spherical beads.

The beam nozzle 11, the wire nozzle 12, and the gas nozzle 13 are fixed to the machining head 10, and thus have fixed positional relationships with one another. That is, the relationships of relative positions among the beam nozzle 11, the gas nozzle 13, and the wire nozzle 12 are fixed by the machining head 10.

A laser oscillator 2, which is the beam source, oscillates the laser beam 24. The laser beam 24 from the laser oscillator 2 propagates through a fiber cable 3, which is an optical transmission line, to the machining head 10. The laser oscillator 2, the fiber cable 3, and the machining head 10 together form an emission unit that emits the laser beam 24 for melting the wire 5, to the workpiece.

The laser beam 24 emitted from the beam nozzle 11 to the workpiece may be non-coaxial or coaxial with a central axis CW of the wire 5. Use of a doughnut-shaped beam, shaped into a doughnut shape, as the laser beam 24, or use of a group of branched, multiple laser beams as the laser beam 24 enables the laser beam 24 emitted from the beam nozzle 11 to the workpiece to be aligned coaxially with the central axis CW of the wire 5. Note that the first embodiment will be described with respect to a case in which the laser beam 24 emitted from the beam nozzle 11 to the workpiece are non-coaxial with the central axis CW of the wire 5.

A gas supply device 7 supplies inert gas 25 through a pipe 8 to the gas nozzle 13. The gas supply device 7, the pipe 8, and the gas nozzle 13 together form a gas supply unit that jets the inert gas 25 toward the machining area 26.

A wire spool 6 including the wire 5 wound therearound is the source of supply of the material. The wire spool 6 rotates in response to the driving of a rotary motor 4, which is a servomotor, thereby causing the wire 5 to be discharged from the wire spool 6. The wire 5 discharged from the wire spool 6 is passed through the wire nozzle 12, and is supplied to the position of irradiation of the laser beam 24. The additive manufacturing apparatus 100 is also capable of drawing out the wire 5 supplied to the position of irradiation of the laser beam 24 from the position of irradiation of the laser beam 24 by reversely rotating the rotary motor 4 in a direction opposite to the direction for discharging the wire 5 from the wire spool 6. In this case, part of the wire 5 discharged from the wire spool 6 near to the wire spool 6 is wound into the wire spool 6. The rotary motor 4, the wire spool 6, and the wire nozzle 12 together form a wire supply unit 19, which is a material supply unit.

Note that the wire nozzle 12 may include an operating mechanism for drawing out the wire 5 from the wire spool 6. The additive manufacturing apparatus 100 includes at least one of the rotary motor 4 for the wire spool 6 and the operating mechanism of the wire nozzle 12, and can thereby supply the wire 5 to the position of irradiation of the laser beam 24. FIG. 1 omits illustration of the operating mechanism of the wire nozzle 12.

A head drive unit 14 moves the machining head 10 along each direction of an X-axis direction, a Y-axis direction, and a Z-axis direction. The X-axis, the Y-axis, and the Z-axis are three axes perpendicular to each other. The X-axis and the Y-axis are axes parallel to the horizontal directions. The Z-axis direction is a vertical direction. The head drive unit 14 includes a servomotor constituting an operating mechanism for moving the machining head 10 in the X-axis direction, a servomotor constituting an operating mechanism for moving the machining head 10 in the Y-axis direction, and a servomotor constituting an operating mechanism for moving the machining head 10 in the Z-axis direction. The head drive unit 14 is an operating mechanism that enables translational movement along each direction of the three axes. FIG. 1 omits illustration of the servomotors. The additive manufacturing apparatus 100 is capable of moving the position of irradiation of the laser beam 24 on the workpiece by moving the machining head 10 using the head drive unit 14. The additive manufacturing apparatus 100 may move the position of irradiation of the laser beam 24 on the workpiece by moving the stage 15.

In the machining head 10 illustrated in FIG. 1, the beam nozzle 11 causes the laser beam 24 to travel in the Z-axis direction from the beam nozzle 11. The wire nozzle 12 is disposed at a position apart from the beam nozzle 11 on the XY-plane, and causes the wire 5 to move forward in an oblique direction with respect to the Z-axis. Note that the wire nozzle 12 may have the fixed direction on the machining head 10 changed to cause the wire 5 to move forward in a direction parallel to the Z-axis. The wire nozzle 12 limits the forward movement of the wire 5 to allow the wire 5 to be supplied to the desired position.

In the machining head 10, the gas nozzle 13 is disposed to be coaxial with the beam nozzle 11 and outer circumferentially with respect to the beam nozzle 11 on the XY-plane. The gas nozzle 13 jets the inert gas 25 to cause the inert gas 25 to follow a central axis CL of the laser beam 24 emitted from the beam nozzle 11. That is, the beam nozzle 11 and the gas nozzle 13 are disposed to be coaxial with each other. Note that the gas nozzle 13 may jet the inert gas 25 in an oblique direction with respect to the Z-axis. That is, the gas nozzle 13 may jet the inert gas 25 in an oblique direction with respect to the central axis CL of the laser beam 24 emitted from the beam nozzle 11.

A rotation mechanism 16 is an operating mechanism that enables rotation of the stage 15 about a first axis and rotation of the stage 15 about a second axis perpendicular to the first axis. In the rotation mechanism 16 illustrated in FIG. 1, the first axis is an axis parallel to the X-axis, and the second axis is an axis parallel to the Y-axis. The rotation mechanism 16 includes a servomotor constituting an operating mechanism for rotating the stage 15 about the first axis, and a servomotor constituting an operating mechanism for rotating the stage 15 about the second axis. The rotation mechanism 16 is an operating mechanism that enables rotational movement about each of the two axes. FIG. 1 omits illustration of the servomotors.

The additive manufacturing apparatus 100 is capable of changing the orientation or the position of the workpiece by rotating the stage 15 using the rotation mechanism 16. That is, the additive manufacturing apparatus 100 is capable of moving the position of irradiation of the laser beam 24 on the workpiece by rotating the stage 15. The additive manufacturing apparatus 100 is also capable of forming a complex shape having a tapered shape by use of the rotation mechanism 16.

The control device 1 controls the additive manufacturing apparatus 100 according to the machining program. The control device 1 is, for example, a numerical control device. The control device 1 controls the material supply unit, the emission unit, and the gas supply unit to thereby provide control to form a shaped object using multiple spherical beads or the like formed by melting the wire 5.

The control device 1 outputs a move command to the head drive unit 14 to thereby control driving of the head drive unit 14. Thus, the control device 1 causes the head drive unit 14 to move the machining head 10 to control the position of the machining head 10. The control device 1 outputs, to the laser oscillator 2, a command dependent on a requirement for beam output power such as beam intensity to thereby control laser oscillation provided by the laser oscillator 2.

The control device 1 outputs, to the rotary motor 4, a command dependent on a requirement for the amount of supply of the material to thereby control driving of the rotary motor 4. The control device 1 adjusts the speed of the wire 5 moving from the wire spool 6 to the irradiation position by providing control of driving of the rotary motor 4. Such speed may hereinafter be referred to as feed speed. The feed speed represents the amount of supply of the material per unit time.

The control device 1 outputs, to the gas supply device 7, a command dependent on the amount of supply of the gas to thereby control the amount of the inert gas 25 to be supplied from the gas supply device 7 to the gas nozzle 13. The control device 1 outputs a rotate command to the rotation mechanism 16 to thereby control driving of the rotation mechanism 16. That is, the control device 1 controls the entire additive manufacturing apparatus 100 by outputting these commands. Thus, the control device 1 controls the wire supply unit 19, the emission unit, the gas supply unit, the head drive unit 14, and the rotation mechanism 16 to thereby cause the additive manufacturing apparatus 100 to form beads.

The shaped object is formed by depositing a molten wire 21 in the machining area 26 using the laser beam 24 emitted from the beam nozzle 11. As illustrated in FIG. 2, the additive manufacturing apparatus 100 supplies the wire 5 to the machining area 26, and emits the laser beam 24 to the wire 5.

In addition, an additive target surface 22 formed of the surface of the base substrate 17 or the surface of the deposit 18 is melted in the machining area 26, thereby forming a molten pool 23. Then, in the machining area 26, the molten wire 21 produced by melting of the wire 5 is welded to the molten pool 23. The additive target surface 22 is a surface to be machined by additive machining, on which the molten wire 21 is welded and the deposit 18 is formed. The machining area 26 is an area to be machined where additive machining is being performed on the additive target surface 22. The additive manufacturing apparatus 100 deposits the molten wire 21 in the machining area 26.

The additive manufacturing apparatus 100 moves the machining head 10 and the stage 15 by causing the head drive unit 14 and the rotation mechanism 16 to cooperate with each other to thereby change the position of the machining area 26. This enables the additive manufacturing apparatus 100 to obtain a shaped object having a desired shape.

A hardware configuration of the control device 1 will now be described. The control device 1 illustrated in FIG. 1 is implemented in such a manner that a control program, which is a program for performing control of the additive manufacturing apparatus 100, is executed in hardware.

FIG. 3 is a block diagram illustrating a hardware configuration of the control device included in the additive manufacturing apparatus according to the first embodiment. The control device 1 includes a central processing unit (CPU) 41, which performs various processing tasks, a random access memory (RAM) 42 including a data storage area, and a read-only memory (ROM) 43, which is a non-volatile memory. The control device 1 also includes an external storage device 44, and an input-output interface 45 for inputting information to the control device 1 and for outputting information from the control device 1. These components illustrated in FIG. 3 are connected to one another via a bus 46.

The CPU 41 executes a control program stored in the ROM 43 or in the external storage device 44. The control device 1 controls the entire additive manufacturing apparatus 100 by use of the CPU 41.

The external storage device 44 is a hard disk drive (HDD) or a solid state drive (SSD). The external storage device 44 stores a control program and various data. The ROM 43 stores a bootloader such as a basic input output system (BIOS) or a unified extensible firmware interface (UEFI), which is a program for control, serving as a basis for a computer or a controller that is the control device 1, where such bootloader is software or a program for controlling hardware elements. Note that the control program may be stored in the ROM 43.

The programs stored in the ROM 43 and in the external storage device 44 are loaded into the RAM 42. The CPU 41 deploys the control program in the RAM 42, and performs various processing tasks. The input-output interface 45 is a connection interface with a device outside the control device 1. The machining program is input to the input-output interface 45. In addition, the input-output interface 45 outputs various types of commands. The control device 1 may include input devices such as a keyboard and a pointing device and an output device such as a display.

The control program may be a program stored in a computer-readable storage medium. The control device 1 may store, in the external storage device 44, the control program stored in a storage medium. The storage medium may be a portable storage medium that is a flexible disk, or a flash memory, which is a semiconductor memory. The control program may be installed into a computer or a controller that is to serve as the control device 1, from another computer or from a server device via a communication network.

Functionality of the control device 1 may be implemented in processing circuitry that is a dedicated hardware element for controlling the additive manufacturing apparatus 100. The processing circuitry is a single circuit, a set of multiple circuits, a programmed processor, a parallel programmed processor, an application specific integrated circuit (ASIC), a field-programmable gate array (FPGA), or a combination thereof. Functionality of the control device 1 may be implemented partially in a dedicated hardware element, and partially in software or firmware.

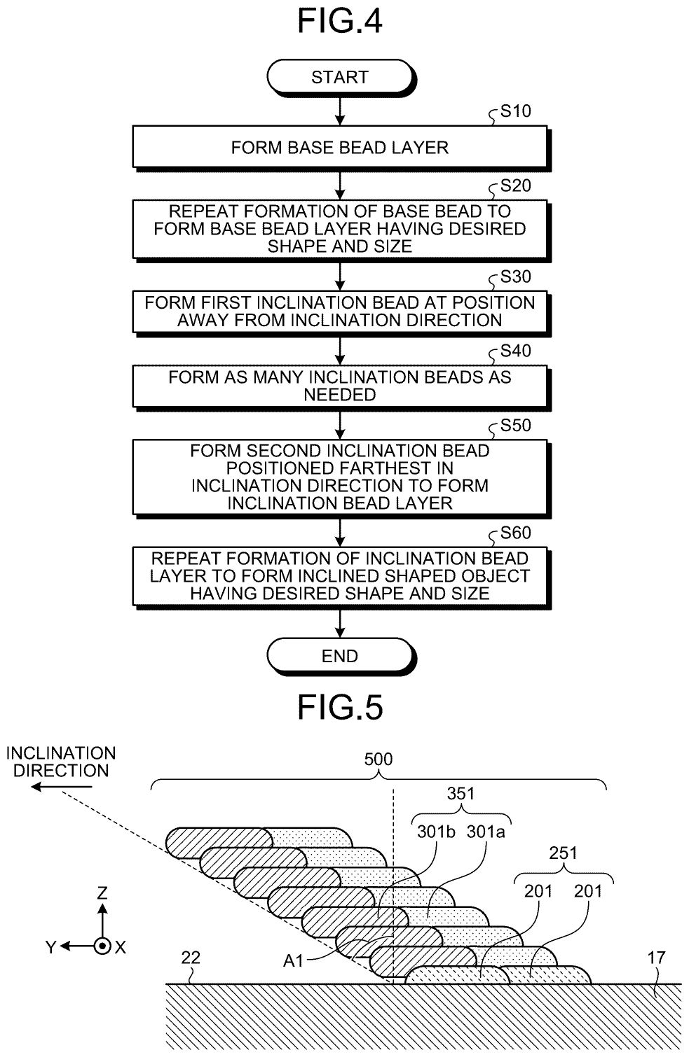

An operation of the additive manufacturing apparatus 100 according to the first embodiment will next be described with reference to FIGS. 4 and 5. FIG. 4 is a flowchart illustrating an operation procedure of the additive manufacturing apparatus according to the first embodiment. FIG. 5 is a schematic diagram illustrating an inclined shaped object formed by the additive manufacturing apparatus according to the first embodiment.

Referring to FIGS. 4 and 5, a case will be described in which inclination bead layers 351 are formed in parallel to the YZ-plane. That is, an inclined shaped object 500 is formed in such a manner that the inclination bead layers 351 extending in a positive Y-direction are stacked on top of another along a positive Z-direction. The inclined shaped object 500 is formed to have a shape in which an upper layer is positioned more forward in a positive Y-direction. This causes the inclined shaped object 500 to become inclined in the positive Y-direction. FIG. 5 illustrates, as an inclination angle A1, the inclination angle that is the angle formed between the inclined shaped object 500 and the positive Z-direction.

The additive manufacturing apparatus 100 forms a base bead layer 251 formed of base beads 201, on the additive target surface 22 of the base substrate 17 (step S10). In this operation, the additive manufacturing apparatus 100 supplies the wire 5 to the irradiation position during emission of the laser beam 24 to the additive target surface 22, and concurrently drives the machining head 10 using the control device 1. The base beads 201 are thus formed. The additive manufacturing apparatus 100 welds the wire 5 while driving the machining head 10, thereby causing the base beads 201 to have a linear shape. That is, the additive manufacturing apparatus 100 welds the wire 5 while linearly moving the machining head 10, thereby linearly joining together the base beads 201 during formation thereof.

The additive manufacturing apparatus 100 repeats formation of each of the base beads 201 to form each of the base bead layers 251 having a desired shape and a desired size (step S20). Thus, the base beads 201 become linear as viewed from above the XY-plane.

Note that the additive manufacturing apparatus 100 may form the base beads 201 in a linear shape or in a curved shape. In addition, the additive manufacturing apparatus 100 may form the base bead layer 251 by a single base bead 201 or by multiple base beads 201. When the base bead layer 251 is to be formed by multiple base beads 201, the additive manufacturing apparatus 100 forms the base beads 201 such that the base beads 201 that has been formed immediately before and the base beads 201 to be formed next are connected to each other.

As described above, when the base bead layer 251 is formed of multiple base beads 201, the base beads 201 are disposed to be linearly aligned. FIG. 5 illustrates a case in which two base beads 201 are formed on the additive target surface 22 along a line extending in the Y-axis direction.

Note that the term “base bead layer 251” may refer to the first layer of the inclined shaped object 500 formed on the additive target surface 22, or may refer to a base shaped object 400 (described later) for depositing an inclined shaped object 501 (described later).

The additive manufacturing apparatus 100 first forms a first inclination bead 301a, which is positioned farthest in a direction opposite the inclination direction in the inclination bead layer 351, to thus start formation of the inclination bead layer 351 illustrated in FIG. 5 (step S30).

The additive manufacturing apparatus 100 forms, for example, as illustrated in FIG. 5, a first layer of the inclination bead layers 351, as the layer on top of the base bead layer 251. In this operation, the additive manufacturing apparatus 100 sequentially forms inclination beads in order from the inclination bead at the farthest position in the direction opposite the positive Y-direction, which is the inclination direction, to form the first inclination bead layer 351. That is, the additive manufacturing apparatus 100 forms inclination beads extending in the positive Y-direction in order from the farthest in the negative Y-direction.

FIG. 5 illustrates a case in which the additive manufacturing apparatus 100 first forms the first inclination bead 301a, which is the first inclination bead, when the inclination bead layer 351 is formed. The additive manufacturing apparatus 100 forms the first inclination bead 301a to cause the bottom surface of the first inclination bead 301a to be connected to the top surfaces of the base beads 201.

Then, the additive manufacturing apparatus 100 forms as many inclination beads as needed for the first inclination bead layer 351, along the positive Y-direction, which is the inclination direction (step S40). That is, when needed, the additive manufacturing apparatus 100 forms as many inclination beads (hereinafter each referred to as intermediate inclination bead) as needed between the first inclination bead 301a and a second inclination bead 301b (described later), which is the last inclination bead of the first layer.

The additive manufacturing apparatus 100 forms a first intermediate inclination bead to cause the first intermediate inclination bead to be connected to the applicable ones of the base beads 201 and to the first inclination bead 301a. The additive manufacturing apparatus 100 forms an L-th (where L is a natural number greater than or equal to 2) intermediate inclination bead to cause the L-th intermediate inclination bead to be connected to the applicable ones of the base beads 201 and to the (L−1)-th intermediate inclination bead. The additive manufacturing apparatus 100 forms the first inclination bead 301a and the intermediate inclination beads to cause the first inclination bead 301a and the intermediate inclination beads to be linearly joined together on the base bead layer 251 as viewed from above the XY-plane.

The additive manufacturing apparatus 100 finally forms the second inclination bead 301b, which is positioned farthest in the inclination direction among the inclination beads of the first layer, to thus form the first inclination bead layer 351 (step S50). The first inclination bead 301a and the second inclination bead 301b have a same height. The second inclination bead 301b is disposed forward relative to the base beads 201 in the positive Y-direction. That is, the second inclination bead 301b is disposed on the applicable one of the base beads 201 to cause the maximum value of the Y-coordinate of the second inclination bead 301b to be greater than the maximum value of the Y-coordinate of the applicable base bead 201. That is, the additive manufacturing apparatus 100 forms the second inclination bead 301b to protrude with respect to the base beads 201. In other words, the additive manufacturing apparatus 100 forms the second inclination bead 301b at a position where part of the bottom surface of the second inclination bead 301b has no contact with the top surface of the base beads 201.

FIG. 5 illustrates a case in which the additive manufacturing apparatus 100 has formed the first inclination bead, i.e., the first inclination bead 301a, and then the last inclination bead, i.e., the second inclination bead 301b, to form the first inclination bead layer 351. In this case, the additive manufacturing apparatus 100 forms the second inclination bead 301b at a position where the second inclination bead 301b comes into contact with the top surface of the applicable base bead 201 and with the side surface of the first inclination bead 301a. In other words, the additive manufacturing apparatus 100 causes the second inclination bead 301b to be connected to the applicable base bead 201 and to the first inclination bead 301a.

In addition, when at least one intermediate inclination bead has been formed, the additive manufacturing apparatus 100 forms the second inclination bead 301b at a position where the second inclination bead 301b comes into contact with the top surface of the applicable base bead 201 and with the side surface of the intermediate inclination bead. In other words, when at least one intermediate inclination bead has been formed, the additive manufacturing apparatus 100 causes the second inclination bead 301b to be connected to the applicable base bead 201 and to the intermediate inclination bead.

After forming the first inclination bead layer 351, the additive manufacturing apparatus 100 forms the second and subsequent inclination bead layers 351 using a process similar to the process used for the first inclination bead layer 351. That is, the additive manufacturing apparatus 100 forms an (N+1)-th (where N is a natural number) inclination bead layer 351 as the layer on top of an N-th inclination bead layer 351. In this operation, the additive manufacturing apparatus 100 sequentially forms inclination beads in order from the inclination bead at the farthest position in the direction opposite the positive Y-direction, which is the inclination direction, to form the (N+1)-th inclination bead layer 351. Then, the additive manufacturing apparatus 100 forms as many intermediate inclination beads as needed for the (N+1)-th inclination bead layer 351, along the positive Y-direction, which is the inclination direction. The additive manufacturing apparatus 100 then finally forms the second inclination bead 301b to form the (N+1)-th inclination bead layer 351.

When no intermediate inclination bead is to be formed, the additive manufacturing apparatus 100 forms the second inclination bead 301b of the (N+1)-th layer at a position where the second inclination bead 301b of the (N+1)-th layer comes into contact with the top surface of the second inclination bead 301b of the N-th layer and with the side surface of the first inclination bead 301a of the (N+1)-th layer. In other words, the additive manufacturing apparatus 100 causes the second inclination bead 301b of the (N+1)-th layer to be connected to the second inclination bead 301b of the N-th layer and to the first inclination bead 301a of the (N+1)-th layer.

In addition, when at least one intermediate inclination bead has been formed, the additive manufacturing apparatus 100 forms the second inclination bead 301b of the (N+1)-th layer at a position where the second inclination bead 301b of the (N+1)-th layer comes into contact with the top surface of the second inclination bead 301b of the N-th layer and with the side surface of the intermediate inclination bead of the N-th layer. In other words, when at least one intermediate inclination bead has been formed, the additive manufacturing apparatus 100 causes the second inclination bead 301b of the (N+1)-th layer to be connected to the second inclination bead 301b of the N-th layer and to the intermediate inclination bead of the (N+1)-th layer.

The second inclination bead 301b of the (N+1)-th layer is disposed forward relative to the second inclination bead 301b of the N-th layer in the positive Y-direction. That is, the second inclination bead 301b of the (N+1)-th layer is disposed on the second inclination bead 301b of the N-th layer to cause the maximum value of the Y-coordinate of the second inclination bead 301b of the (N+1)-th layer to be greater than the maximum value of the Y-coordinate of the second inclination bead 301b of the N-th layer. That is, the additive manufacturing apparatus 100 forms the second inclination bead 301b of the (N+1)-th layer to protrude with respect to the second inclination bead 301b of the N-th layer. In other words, the additive manufacturing apparatus 100 forms the second inclination bead 301b of the (N+1)-th layer at a position where part of the bottom surface of the second inclination bead 301b of the (N+1)-th layer has no contact with the top surface of the second inclination bead 301b of the N-th layer.

The additive manufacturing apparatus 100 repeats formation of the inclination bead layer 351 to form the inclined shaped object 500 having a desired shape and a desired size (step S60).

When no intermediate inclination bead is formed, the first inclination bead 301a of the N-th layer is a first bead, and the second inclination bead 301b of the N-th layer is a second bead. In addition, when no intermediate inclination bead is formed, the first inclination bead 301a of the (N+1)-th layer is a third bead, and the second inclination bead 301b of the (N+1)-th layer is a fourth bead.

When at least one intermediate inclination bead is formed, the last-formed intermediate inclination bead among the intermediate inclination beads of the N-th layer is the first bead, and the second inclination bead 301b of the N-th layer is the second bead. In addition, when at least one intermediate inclination bead is formed, the last-formed intermediate inclination bead among the intermediate inclination beads of the (N+1)-th layer is the third bead, and the second inclination bead 301b of the (N+1)-th layer is the fourth bead.

Furthermore, the N-th inclination bead layer 351 is a lower bead layer, and the (N+1)-th inclination bead layer 351 is an upper bead layer.

The second inclination bead 301b is positioned on the base bead layer 251 or on the inclination bead layer 351 formed thereunder, and is adjacent to a bead such as the first inclination bead 301a, thereby causing the second inclination bead 301b to come into contact in a large area with other beads other than the second inclination bead 301b. Thus, the second inclination bead 301b is drawn, with great force, toward such other beads by action of surface tension of such other beads. This enables the additive manufacturing apparatus 100 to form the inclination bead layer 351 without allowing the inclination bead layer 351 to significantly bend downward in the direction of gravitational force. That is, formation of the inclination bead layer 351 using such method allows the additive manufacturing apparatus 100 to form the inclination bead layer 351 without allowing the second inclination bead 301b to significantly bend downward in the direction of gravitational force.

As described above, the additive manufacturing apparatus 100 is capable of forming the inclination bead layer 351 without allowing the second inclination bead 301b to bend downward even when neither the base bead layer 251 nor the inclination bead layer 351 having a sufficient size is formed immediately under the second inclination bead 301b, and part of the second inclination bead 301b protrudes to be floating in the air.

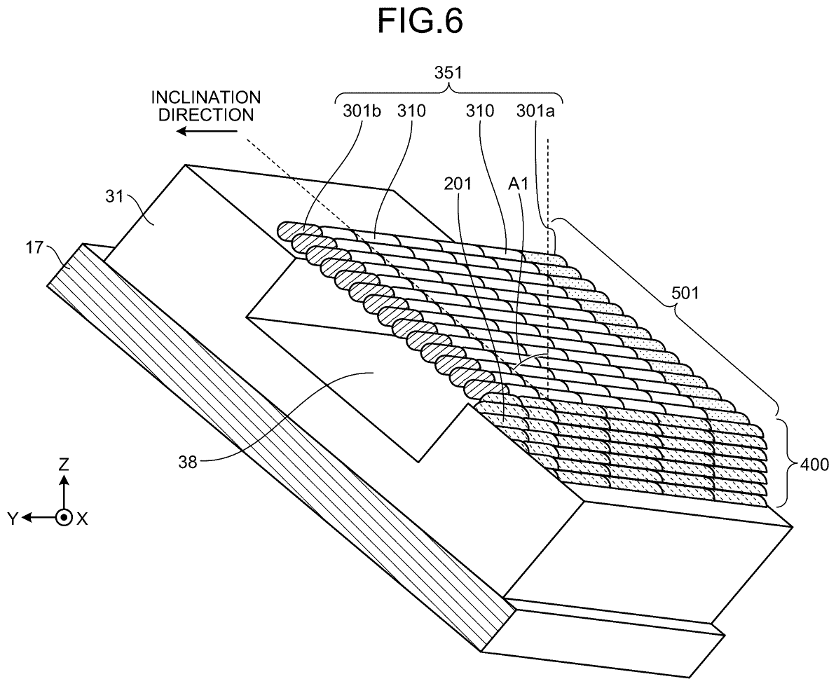

An inclined shaped object formed by the additive manufacturing apparatus 100 when the base substrate 17 is inclined will now be described. FIG. 6 is a schematic diagram illustrating an inclined shaped object formed on an inclined base substrate by the additive manufacturing apparatus according to the first embodiment.

The following description is provided in the context of an inclined shaped object 501 formed on an upper base substrate 31 by the additive manufacturing apparatus 100 when the upper base substrate 31 is formed on the inclined base substrate 17.

The base substrate 17 is formed of a plate-shaped member. The top surface of the plate-shaped member is inclined with respect to the XY-plane, which is a horizontal plane. The rotation mechanism 16 inclines the base substrate 17 by rotating the stage 15.

The upper base substrate 31 has a shape having a groove 38 in part of a rectangular parallelepiped. The upper base substrate 31 has a bottom surface joined to the top surface of the base substrate 17. The groove 38 is formed on the top surface of the upper base substrate 31. Due to such configuration, the top surface of the upper base substrate 31 is parallel to the top surface of the base substrate 17. That is, the top surface of the upper base substrate 31 is inclined with respect to the XY-plane, which is a horizontal plane. Thus, the top surface of the rectangular parallelepiped region in which the groove 38 is formed is also inclined with respect to the XY-plane. The additive manufacturing apparatus 100 forms the inclined shaped object 501 to cover the groove 38 formed in the upper base substrate 31. The top surface of the rectangular parallelepiped region in which the groove 38 is formed serves as the additive target surface 22.

In this case, the additive manufacturing apparatus 100 produces a base shaped object 400 on the top surface of the upper base substrate 31, and forms the inclined shaped object 501 using the base shaped object 400 as the foundation. Specifically, the additive manufacturing apparatus 100 stacks base bead layers 251 each formed of multiple base beads 201, one on top of another along the Z-axis direction to thus form in advance the base shaped object 400 for deposition of the inclined shaped object 501. In this manner, the additive manufacturing apparatus 100 forms the base shaped object 400 as needed.

Also in this case, the additive manufacturing apparatus 100 forms, on the base shaped object 400, the first inclination bead 301a, which is positioned farthest in the inclination bead layer 351 in a direction opposite the inclination direction, in the positive Y-direction, which is the inclination direction.

As illustrated in FIGS. 5 and 6, the additive manufacturing apparatus 100 forms as many intermediate inclination beads as needed along a line of extension of the first inclination bead 301a. FIG. 6 illustrates a case in which the additive manufacturing apparatus 100 has formed intermediate inclination beads 310 along a line of extension of each of the first inclination beads 301a.

The additive manufacturing apparatus 100 then forms the second inclination bead 301b, positioned farthest in the inclination direction in the inclination bead layer 351, in the positive Y-direction, which is the inclination direction. The additive manufacturing apparatus 100 forms the inclination beads to cause the inclination beads to be linearly connected to each other from the first inclination bead 301a to the second inclination bead 301b. Thus, the inclination bead layer 351 is formed linearly.

The additive manufacturing apparatus 100 repeats the process of forming an inclination bead layer 351 extending to protrude in the positive Y-direction with respect to the lower inclination bead layer 351, on the lower inclination bead layer 351 to thereby form the inclined shaped object 500 or 501 having a desired shape and a desired size. This enables the additive manufacturing apparatus 100 to form the inclined shaped object 500 or 501 without causing significant downward bending in the direction of gravitational force even when the forming direction is oblique.

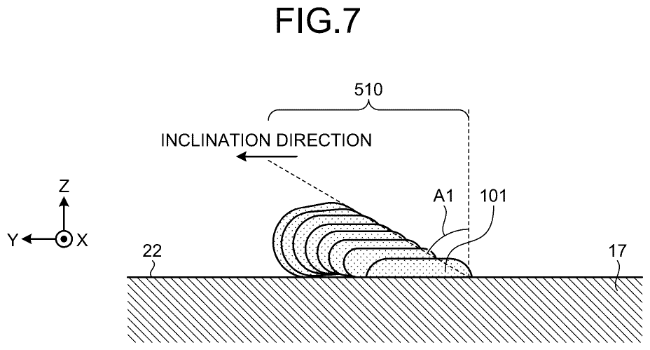

An additive manufacturing apparatus in a comparative example will next be described. FIG. 7 is a diagram for describing an inclined shaped object formed by an additive manufacturing apparatus of a comparative example. The additive manufacturing apparatus of the comparative example sequentially stacks beads 101 one on top of another one by one to form an inclined shaped object 510. In this operation, the additive manufacturing apparatus of the comparative example stacks the beads 101 one on top of another each with a small positional shift in the positive Y-direction, which is the inclination direction. That is, the additive manufacturing apparatus of the comparative example forms an (M+1)-th (where M is a natural number) layer to cause the (M+1)-th layer to be positioned forward with respect to the M-th layer in the direction of positive Y when the bead 101 of the (M+1)-th layer is formed as the layer on top of the bead 101 of the M-th layer.

When the additive manufacturing apparatus of the comparative example increases the amount of positional shift of the bead 101 to increase the inclination angle A1, the stacked bead 101 will have a reduced contact area with the bead 101 of the immediately lower layer. This causes the stacked bead 101 to be subjected to force that draws the stacked bead 101 in the negative Z-direction due to gravity, which is greater than force that draws the stacked bead 101 in a direction parallel to the XY-plane due to surface tension. This causes the stacked bead 101 to bend downward.

Bond number Bo expressed by Equation (1) below is a metric that represents which force is greater when gravitational force and surface tension are compared. In Equation (1), Δρ is a density difference (kg/m²), g is gravitational force, L is a characteristic length scale (m), and σ is surface tension (N/m).

Bo=ΔρgL²/σ (1)

Equation (1) means that a smaller Bond number Bo indicates greater surface tension in comparison with gravitational force. As shown in Equation (1), when a comparison is made between the intensity of gravitational force and the intensity of surface tension, the intensity of gravitational force and the intensity of surface tension depend on a physical property value specific to the material used in forming, or on the size of the bead. For example, it is known that use of an inclination angle A1 of or above 60 degrees with use of a material such as a nickel-based alloy, a titanium alloy, or a stainless steel alloy, which is often used by an additive manufacturing apparatus for metals, causes the additive manufacturing apparatus of the comparative example to fail to prevent downward bending due to gravity, and to undergo loss of shape of the inclined shaped object 501. It is also known that use of an inclination angle that causes the bead 101 to protrude by 40% or more of the width of the bead 101 in the extending direction (i.e., width in the Y-axis direction) with respect to the bead 101 of the immediately lower layer causes the additive manufacturing apparatus of the comparative example to fail to prevent downward bending due to gravity, and to undergo loss of shape of the inclined shaped object 501.

The additive manufacturing apparatus 100 of the first embodiment forms the second inclination bead 301b to cause the second inclination bead 301b to be connected to the first inclination bead 301a or to the intermediate inclination bead 310, and can thus prevent a loss of shape of the inclined shaped object 500.

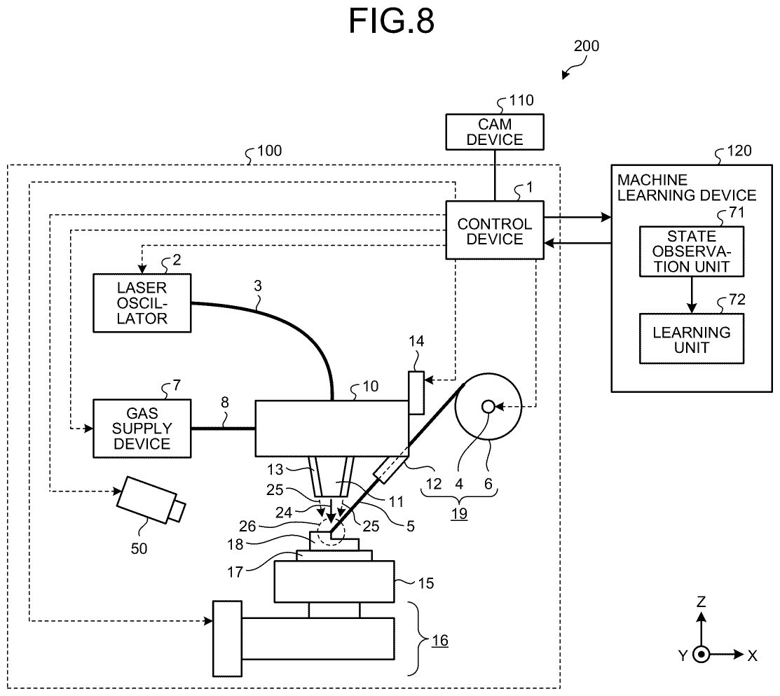

Note that the additive manufacturing apparatus 100 may use machine learning to determine a condition in additive manufacturing for preventing downward bending or a condition in additive manufacturing for reducing downward bending. FIG. 8 is a diagram illustrating a configuration of an additive manufacturing system according to the first embodiment. An additive manufacturing system 200 includes the additive manufacturing apparatus 100 and a machine learning device 120.

The machine learning device 120 is connected to the control device 1 of the additive manufacturing apparatus 100. The machine learning device 120 includes a state observation unit 71, which obtains, as state quantities, a condition in additive manufacturing, and states such as scattered light in additive manufacturing, a load applied on the wire 5 in additive manufacturing, and the height of the inclined shaped object 500 or 501; and a learning unit 72, which learns a relationship between the condition in additive manufacturing and a result of additive manufacturing, based on the state quantities.

Examples of the condition in additive manufacturing include the material of the build material, the inclination angle, the interval between or the width of the first inclination beads 301a or the second inclination beads 301b, parameters set for the gas supply device 7, parameters set for the laser oscillator 2, and a parameter relating to the drive shaft such as the scanning speed of the laser beam 24. The parameters set for the laser oscillator 2 are, for example, the laser output power, the beam diameter, and/or the like.

Examples of manufacturing results include the magnitude of downward bending of the second inclination bead 301b, a result of measurement about the shape of the inclined shaped object 500, which is the final shaped object, and a result of measurement of the temperature during forming and the like.

The control device 1 may also include a learned learner that uses a result of learning performed by the learning unit 72 described above. Examples of the result of learning include a model obtained by learning and data obtained by learning.

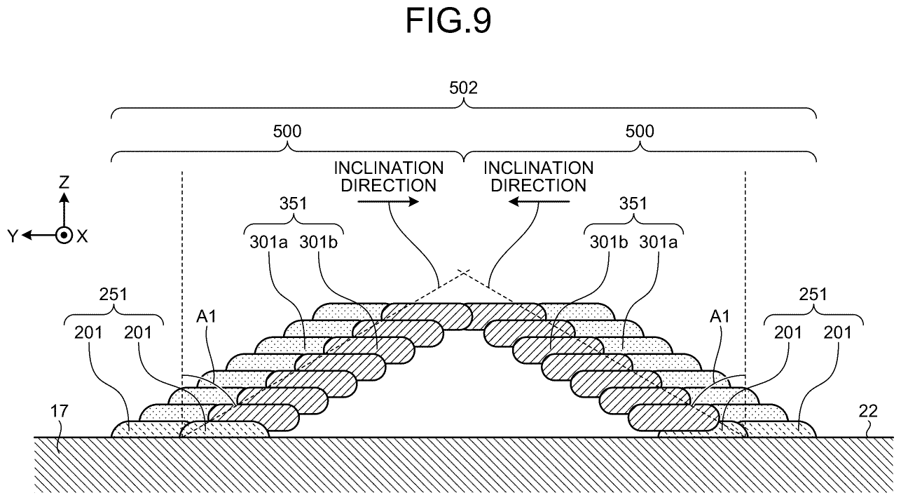

The additive manufacturing apparatus 100 may combine the inclined shaped objects 500 to form a tunnel-shaped object having a hollow structure. FIG. 9 is a schematic diagram illustrating an example of shaped object formed by a combination of the inclined shaped objects by the additive manufacturing apparatus according to the first embodiment.

The additive manufacturing apparatus 100 is capable of forming a tunnel-shaped inclined shaped object 502 having a hollow structure by combining two or more inclined shaped objects 500 described above. In this case, the additive manufacturing apparatus 100 forms the inclined shaped objects 500 to cause the topmost layers of the inclination bead layers 351 of the respective inclined shaped objects 500 to be connected to each other.

For example, the additive manufacturing apparatus 100 connects the inclined shaped object 500 having an inclination direction in the positive Y-direction and the inclined shaped object 500 having an inclination direction in the negative Y-direction at the topmost layers of the inclination bead layers 351 to thus form the tunnel-shaped inclined shaped object 502. That is, the additive manufacturing apparatus 100 forms the tunnel-shaped inclined shaped object 502 by connecting together the end portion in the positive Y-direction of the topmost layer of the inclined shaped object 500 having an inclination direction in the positive Y-direction and the end portion in the negative Y-direction of the topmost layer of the inclined shaped object 500 having an inclination direction in the negative Y-direction.

Thus, in this first embodiment, the additive manufacturing apparatus 100 forms the second inclination bead 301b at a position where the second inclination bead 301b is connected to the first inclination bead 301a, and the second inclination bead 301b has no contact with the immediately lower one of the inclination bead layers 351 when the inclination bead layer 351 is formed. The additive manufacturing apparatus 100 can accordingly prevent the second inclination bead 301b, which is a deposited molten bead, from bending downward due to action of gravity. This enables the additive manufacturing apparatus 100 to easily form an inclined wall with a simple configuration and to form the inclined shaped objects 500 to 502 with high precision without strictly controlling the position of irradiation of the laser beam 24.

In addition, as described referring to FIG. 6, the additive manufacturing apparatus 100 forms the base shaped object 400 for forming the inclined shaped object 501 over the recess or groove portion, and can thus form the inclined shaped object 501 that seals the recess or groove portion.

### Second Embodiment

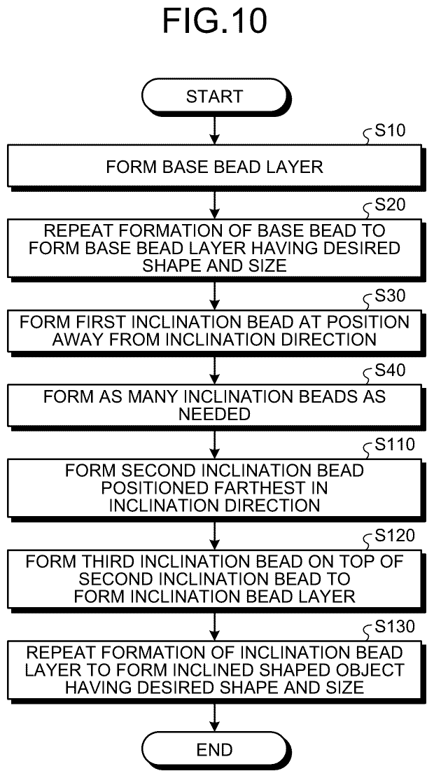

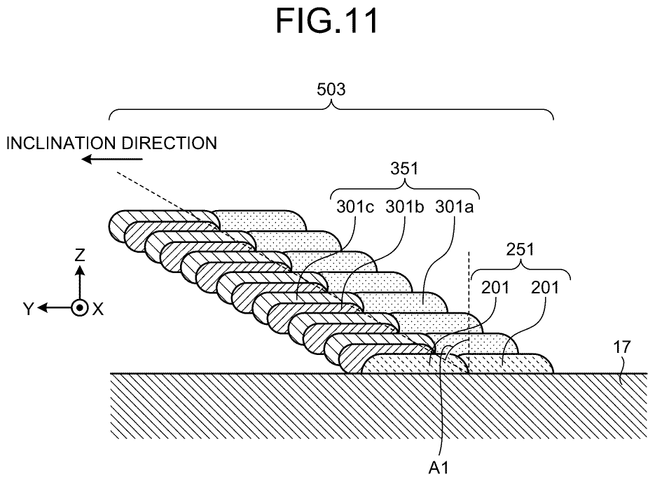

A second embodiment will next be described with reference to FIGS. 10 and 11. In the second embodiment, the last-formed inclination bead of each of the inclination bead layers 351 is formed by stacking multiple beads on top of another. The additive manufacturing apparatus 100 of the second embodiment is configured similarly to the additive manufacturing apparatus 100 of the first embodiment.

FIG. 10 is a flowchart illustrating an operation procedure of the additive manufacturing apparatus according to the second embodiment. FIG. 11 is a schematic diagram illustrating an inclined shaped object formed by the additive manufacturing apparatus according to the second embodiment. Among the operations illustrated in FIG. 10, operations similar to the operations described with reference to FIG. 4 will not be described.

Similarly to the first embodiment, the additive manufacturing apparatus 100 performs the operations from step S10 to step S40. Then, the additive manufacturing apparatus 100 forms the second inclination bead 301b, positioned farthest in the inclination direction among the inclination beads of the first layer (step S110).

When no intermediate inclination bead 310 has been formed, the additive manufacturing apparatus 100 forms the second inclination bead 301b to cause the second inclination bead 301b to be connected to the applicable base bead 201 and to the first inclination bead 301a. Note that when at least one intermediate inclination bead 310 has been formed, the additive manufacturing apparatus 100 forms the second inclination bead 301b to cause the second inclination bead 301b to be connected to the applicable base bead 201 and to the intermediate inclination bead 310.

The second inclination bead 301b in the second embodiment has a lower thickness than the thickness of the second inclination bead 301b in the first embodiment. That is, the second inclination bead 301b in the second embodiment has a height less than the height of the second inclination bead 301b in the first embodiment.

The additive manufacturing apparatus 100 forms a third inclination bead 301c on top of (in the positive Z-direction of) the second inclination bead 301b to form the first inclination bead layer 351 (step S120). That is, the additive manufacturing apparatus 100 forms the third inclination bead 301c to cover the top surface of the second inclination bead 301b.

As described above, the additive manufacturing apparatus 100 stacks the third inclination bead 301c on top of the second inclination bead 301b to form the last-formed inclination bead of each of the inclination bead layers 351 using multiple layers of beads.

The second inclination bead 301b and the third inclination bead 301c together have a combined height that is the same as the height of the first inclination bead 301a. In addition, the third inclination bead 301c has a length in the positive Y-direction (i.e., width) greater than the length of the second inclination bead 301b in the positive Y-direction. In other words, the third inclination bead 301c extends farther in the positive Y-direction than the second inclination bead 301b.

When no intermediate inclination bead 310 has been formed, the additive manufacturing apparatus 100 forms the third inclination bead 301c to cause the third inclination bead 301c to come into contact with the applicable base bead 201, with the first inclination bead 301a, and with the second inclination bead 301b. Alternatively, when at least one intermediate inclination bead 310 has been formed, the additive manufacturing apparatus 100 forms the third inclination bead 301c to cause the third inclination bead 301c to be connected to the applicable base bead 201, to the intermediate inclination bead 310, and to the second inclination bead 301b.

FIG. 11 illustrates a case in which the additive manufacturing apparatus 100 has formed the first inclination bead, i.e., the first inclination bead 301a, and then the second inclination bead 301b and the third inclination bead 301c to form the first inclination bead layer 351.

After forming the first inclination bead layer 351, the additive manufacturing apparatus 100 forms the second and subsequent inclination bead layers 351 using a process similar to the process used for the first inclination bead layer 351. The additive manufacturing apparatus 100 repeats formation of the inclination bead layer 351 to form an inclined shaped object 503 having a desired shape and a desired size (step S130). As described above, the additive manufacturing apparatus 100 forms the inclined shaped object 503 having an inclination, using two beads, i.e., the second inclination bead 301b and the third inclination bead 301c.

When no intermediate inclination bead 310 is formed, the first inclination bead 301a of the N-th layer is the first bead, and the second inclination bead 301b and the third inclination bead 301c of the N-th layer are each the second bead. In addition, when no intermediate inclination bead 310 is formed, the first inclination bead 301a of the (N+1)-th layer is the third bead, and the second inclination bead 301b and the third inclination bead 301c of the (N+1)-th layer are each the fourth bead.

When at least one intermediate inclination bead 310 is formed, the last-formed intermediate inclination bead 310 among the intermediate inclination beads 310 of the N-th layer is the first bead, and the second inclination bead 301b and the third inclination bead 301c of the N-th layer are each the second bead. In addition, when at least one intermediate inclination bead 310 is formed, the last-formed intermediate inclination bead 310 among the intermediate inclination beads 310 of the (N+1)-th layer is the third bead, and the second inclination bead 301b and the third inclination bead 301c of the (N+1)-th layer are each the fourth bead.

The additive manufacturing apparatus 100 is capable of stacking the second inclination bead 301b without causing downward bending, due to force of attraction from nearby beads as described in the first embodiment. However, depending on the type of the metal, it may be difficult to completely prevent the second inclination bead 301b from flowing into a space under the second inclination bead 301b. Even in such case, the additive manufacturing apparatus 100 of the second embodiment is capable of forming the third inclination bead 301c in an amount equivalent to the amount of the second inclination bead 301b that has flowed to under the second inclination bead 301b. In this case, the second inclination bead 301b will have a bead height less than the bead height of the first inclination bead 301a, which is a nearby bead, but the additive manufacturing apparatus 100 is capable of compensating for the portion having the reduced height using the third inclination bead 301c. That is, the additive manufacturing apparatus 100 forms the third inclination bead 301c for compensating for the portion having the reduced height of the second inclination bead 301b.

The additive manufacturing apparatus 100 can prevent downward bending of the second inclination bead 301b owing to an effect similar to the effect of the first embodiment, thereby eliminating the need to stack the third inclination bead 301c for height correction as height as the height of the second inclination bead 301b. It is sufficient for the additive manufacturing apparatus 100 to form the third inclination bead 301c having a height about half the height of the second inclination bead 301b, on the second inclination bead 301b.

When stacking the third inclination bead 301c having a height about half the height of the second inclination bead 301b, the additive manufacturing apparatus 100 provides control such as to increase the scanning speed of the laser beam 24 and/or to reduce the feed speed of the wire 5. That is, when the third inclination bead 301c is stacked, the additive manufacturing apparatus 100, for example, uses a higher scanning speed of the laser beam 24 than that of when the second inclination bead 301b is stacked. Alternatively or additionally, when the third inclination bead 301c is stacked, the additive manufacturing apparatus 100, for example, uses a lower feed speed of the wire 5 than that of when the second inclination bead 301b is stacked.

The additive manufacturing apparatus 100 does not form the third inclination bead 301c at the completely same position as the second inclination bead 301b, but shifts the stacking position by the bead height of the second inclination bead 301b in the positive Z-direction in formation of the third inclination bead 301c. This enables the additive manufacturing apparatus 100 to prevent the wire 5 from interfering with the second inclination bead 301b.

In addition, similarly to the first embodiment, the additive manufacturing apparatus 100 is also capable of forming the inclined shaped object 501 having the structure illustrated in FIG. 6 or the inclined shaped object 502 having the structure illustrated in FIG. 9.

According to the second embodiment, as described above, the additive manufacturing apparatus 100 stacks the third inclination bead 301c on top of the second inclination bead 301b, and can thus correct the height difference from a bead near the second inclination bead 301b. This enables the additive manufacturing apparatus 100 to form the inclined shaped object 503 with higher precision than in the first embodiment.

### Third Embodiment

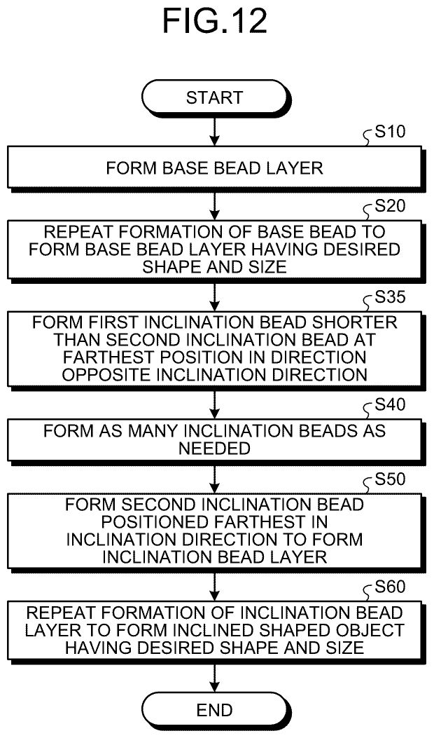

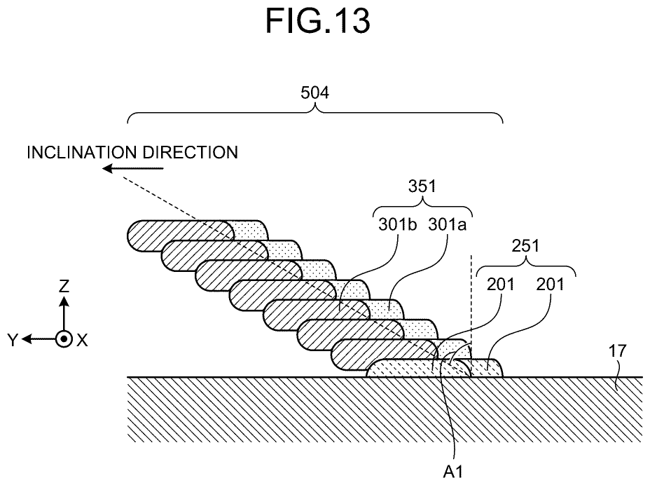

A third embodiment will next be described with reference to FIGS. 12 and 13. In the third embodiment, the first inclination bead 301a is formed to be shorter than the second inclination bead 301b. The additive manufacturing apparatus 100 of the third embodiment is configured similarly to the additive manufacturing apparatus 100 of the first embodiment.

FIG. 12 is a flowchart illustrating an operation procedure of the additive manufacturing apparatus according to the third embodiment. FIG. 13 is a schematic diagram illustrating an inclined shaped object formed by the additive manufacturing apparatus according to the third embodiment. Among the operations illustrated in FIG. 12, operations similar to the operations described with reference to FIG. 4 will not be described.

The additive manufacturing apparatus 100 forms the base bead layer 251 formed of the base beads 201, on the additive target surface 22 of the base substrate 17 (step S10). In this operation, the additive manufacturing apparatus 100 forms the base bead 201 positioned in a direction opposite the inclination direction to be shorter than the base bead 201 to be positioned in the inclination direction. That is, the additive manufacturing apparatus 100 forms the base bead 201 in the negative Y-direction to be shorter than the base bead 201 in the positive Y-direction. The additive manufacturing apparatus 100 forms the base bead layer 251 using a process similar to the process of the first embodiment.

The additive manufacturing apparatus 100 repeats formation of each of the base beads 201 to form the base bead layer 251 having a desired shape and a desired size (step S20). Then, the additive manufacturing apparatus 100 performs an operation of step S35 instead of the operation of step S30.

Specifically, after performing the operation of step S20, the additive manufacturing apparatus 100 forms the first inclination bead 301a shorter than the second inclination bead 301b, at the farthest position in the direction opposite the inclination direction in the inclination bead layer 351 to thus start formation of the inclination bead layer 351 illustrated in FIG. 13 (step S35). The first inclination bead 301a is a bead having a shorter width in the Y-axis direction than the corresponding width of the second inclination bead 301b.

As described above, the additive manufacturing apparatus 100 forms the first inclination bead 301a to have a width shorter than the width of the second inclination bead 301b. That is, the additive manufacturing apparatus 100 forms the first inclination bead 301a to have a width in the extending direction shorter than the width in the extending direction, of the second inclination bead 301b.

Force by the first inclination bead 301a of attracting the second inclination bead 301b depends predominantly on the magnitude of the area of the second inclination bead b in contact with the first inclination bead 301a. This allows the additive manufacturing apparatus 100 to form the inclination bead layer 351 without decreasing the effect of preventing downward bending of the second inclination bead 301b even when the first inclination bead 301a is formed to be shorter than the second inclination bead 301b.

When the first inclination bead 301a is to be formed to be shorter than the second inclination bead 301b, the additive manufacturing apparatus 100 provides control such as to increase the scanning speed of the laser beam 24 and/or to reduce the laser output power. That is, when the first inclination bead 301a is formed, the additive manufacturing apparatus 100, for example, uses a higher scanning speed of the laser beam 24 than that of when the second inclination bead 301b is formed. Alternatively or additionally, when the first inclination bead 301a is formed, the additive manufacturing apparatus 100, for example, uses a lower laser output power than that of when the second inclination bead 301b is formed.

After forming the first inclination bead 301a, the additive manufacturing apparatus 100 performs the operations from step S40 to step S60 similarly to the first embodiment. The additive manufacturing apparatus 100 thus forms an inclined shaped object 504 illustrated in FIG. 13.

According to the third embodiment, as described above, the additive manufacturing apparatus 100 forms the first inclination bead 301a to be shorter than the second inclination bead 301b, and can thus reduce the width of the inclination bead layer 351. This enables the additive manufacturing apparatus 100 to form the inclined shaped object 504 to have a reduced width, and can thus form a high-precision inclined shaped object 504.

### Fourth Embodiment

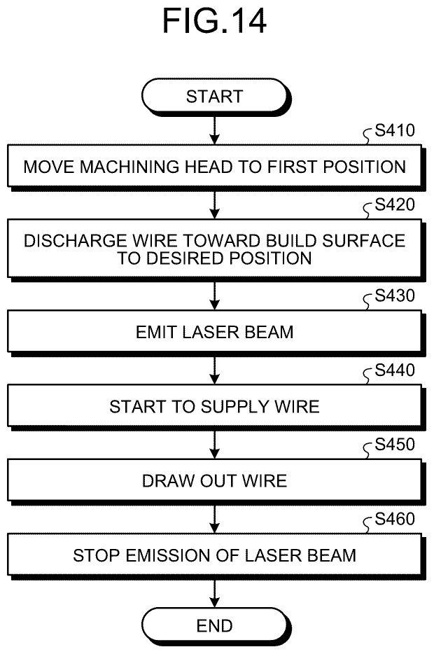

A fourth embodiment will next be described with reference to FIGS. 14 to 16. In the fourth embodiment, the additive manufacturing apparatus 100 forms an inclined shaped object (e.g., the inclined shaped object 500) using a spherical bead. The additive manufacturing apparatus 100 of the fourth embodiment is configured similarly to the additive manufacturing apparatus 100 of the first embodiment. The additive manufacturing apparatus 100 of the fourth embodiment forms an inclined shaped object in a similar manner to the operation and processing described in relation to the first through third embodiments. The following description describes an operation and processing when the additive manufacturing apparatus 100 according to the fourth embodiment forms a spherical bead.

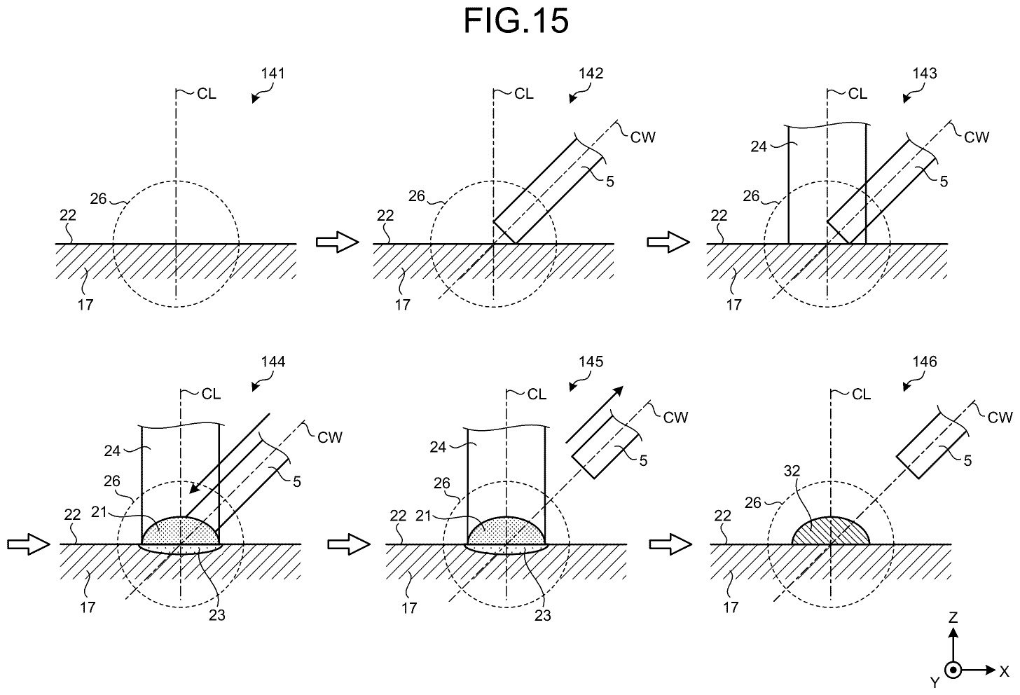

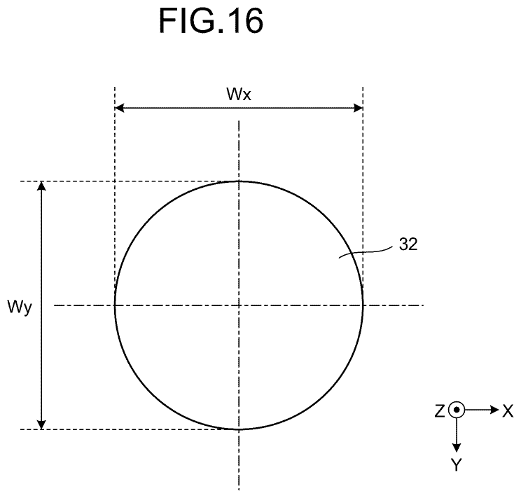

FIG. 14 is a flowchart illustrating an operation procedure when a spherical bead is formed by the additive manufacturing apparatus according to the fourth embodiment. FIG. 15 is a diagram for describing a method for producing a spherical bead to be produced by the additive manufacturing apparatus according to the fourth embodiment. FIG. 16 is a schematic diagram illustrating an inclined shaped object formed by the additive manufacturing apparatus according to the fourth embodiment. FIG. 16 illustrates a bottom view of a spherical bead 32 when the spherical bead 32 is viewed from the negative Z-direction.

The machining head 10 is moved to a predetermined first position above the machining area 26 on the additive target surface 22 of the base substrate 17 (step S410), and is then stopped. Specifically, the machining head 10 is moved to the first position, where the central axis CL of the laser beam 24 emitted from the beam nozzle 11 coincides with the center position of the machining area 26 on the additive target surface 22 (state 141). The additive target surface 22 in this situation is a surface on which the spherical bead 32 is deposited on the base substrate 17, and is the top surface of the base substrate 17 placed on the stage 15.

Next, the wire nozzle 12 discharges the wire 5 toward the additive target surface 22 to a desired position (step S420). Specifically, the wire nozzle 12 discharges the wire 5 in an oblique direction from above the machining area 26 toward the machining area 26 on the additive target surface 22 (state 142).

The operation of discharging the wire 5 performed by the wire nozzle 12 is an operation of moving the wire 5 forward from the wire nozzle 12 toward the position of irradiation of the laser beam 24 in the machining area 26 of the additive target surface 22 to thereby move the wire 5 forward to the irradiation position. The wire nozzle 12 thereby brings the tip of the wire 5 into contact with the additive target surface 22. In this operation, the central axis CW of the wire 5 discharged from the wire nozzle 12 and in contact with the additive target surface 22, and the central axis CL of the laser beam 24 emitted on the machining area 26 cross each other on the surface of the additive target surface 22. The central axis CW of the wire 5 preferably crosses the surface of the additive target surface 22 at a position inside a beam radius of the laser beam 24 on the side nearer to the wire nozzle 12 from the central axis CL of the laser beam 24 emitted to the machining area 26. This enables the additive manufacturing apparatus 100 to form, on the additive target surface 22, the spherical bead 32 in an area around the intersection between the central axis CW of the wire 5 and the central axis CL of the laser beam 24 emitted to the machining area 26.

Next, the additive manufacturing apparatus 100 emits the laser beam 24 toward the machining area 26 on the additive target surface 22 to thus irradiate the wire 5 placed in the machining area 26 on the additive target surface 22 with the laser beam 24 (step S430) (state 143).

In addition, the additive manufacturing apparatus 100 starts jetting of the inert gas 25 from the gas nozzle 13 to the machining area 26 in conjunction with emission of the laser beam 24. In this operation, the additive manufacturing apparatus 100 preferably jets the inert gas 25 from the gas nozzle 13 for a certain predetermined time period before emitting the laser beam 24 to the additive target surface 22. This enables the additive manufacturing apparatus 100 to purge, from inside the gas nozzle 13, active gas such as oxygen remaining in the gas nozzle 13.

Next, the wire nozzle 12 starts to supply the wire 5 to the machining area 26 (step S440). That is, the wire nozzle 12 further discharges the wire 5 toward the additive target surface 22. This causes the molten wire 21 to be welded to the additive target surface 22, where the molten wire 21 is a product of melting of the wire 5 previously placed in the machining area 26 and of the wire 5 supplied to the machining area 26 after starting of emission of the laser beam 24 (state 144). That is, in the machining area 26, the additive target surface 22 is melted to form the molten pool 23, and the molten wire 21 is welded to the molten pool 23. This forms the spherical bead 32, which is the deposit 18, in the machining area 26 of the additive target surface 22. The additive manufacturing apparatus 100 thereafter continues supplying the wire 5 to the machining area 26 for a predetermined time period of supply.

The additive manufacturing apparatus 100 does not actuate the head drive unit 14 during melting of the wire 5, and causes the head drive unit 14 to stay in that position to melt the wire 5 to form the spherical bead 32. As illustrated in FIG. 16, the spherical bead 32 has a circular shape as viewed from the negative Z-direction, and a width Wx and a width Wy are different from each other in length in a range of a ratio width Wx/width Wy of about 0.5 to 2.0. The width Wx is a dimension of the spherical bead 32 in the X-direction. The width Wy is a dimension of the spherical bead 32 in the Y-direction.

The additive manufacturing apparatus 100 is capable of adjusting the feed speed of the wire 5 by the rotational speed of the rotary motor 4. The feed speed of the wire 5 is limited by output power of the laser beam 24. That is, there is a correlation between the feed speed of the wire 5 for allowing appropriate welding of the molten wire 21 to the machining area 26, and the output power of the laser beam 24. The additive manufacturing apparatus 100 can increase the speed of forming the spherical bead 32, which is a bead having a ball shape, by increasing the output power of the laser beam 24.

Too high a feed speed of the wire 5 with respect to the output power of the laser beam 24 will result in incomplete melting and remaining of the wire 5. A lower feed speed of the wire 5 with respect to the output power of the laser beam 24 causes the wire 5 to be heated excessively, and the molten wire 21 to fall dropwise from the wire 5, thereby preventing the wire 5 from being welded in a desired shape. Accordingly, to completely melt the wire 5 supplied to the machining area 26 and to weld the molten wire 21 in a desired shape, the additive manufacturing apparatus 100 sets a feed speed of the wire 5 to a proper speed with respect to the output power of the laser beam 24.

The additive manufacturing apparatus 100 is also capable of adjusting the size of the spherical bead 32 by changing the time period of supplying the wire 5 and the time period of emitting the laser beam 24. The additive manufacturing apparatus 100 can form a spherical bead 32 having a large diameter by increasing the time period of supplying the wire 5 and the time period of emitting the laser beam 24. In contrast, the additive manufacturing apparatus 100 can form a spherical bead 32 having a small diameter by reducing the time period of supplying the wire 5 and the time period of emitting the laser beam 24.

After continuation of the supply of the wire 5 to the machining area 26 for a predetermined time period of supply, the additive manufacturing apparatus 100 draws out the wire 5 from the machining area 26 (step S450) (state 145).

Next, the additive manufacturing apparatus 100 stops the laser oscillator 2 to stop emission of the laser beam 24 to the machining area 26 (step S460) (state 146). The spherical bead 32 is thus formed. In this operation, the gas nozzle 13 does not stop and continues jetting the inert gas 25 toward the workpiece. That is, after stopping of the laser oscillator 2, the gas nozzle 13 continues jetting the inert gas 25 toward the machining area 26 for a predetermined continuation time.

The continuation time during which the inert gas 25 is continued to be jetted from the gas nozzle 13 toward the workpiece is a time for the temperature of the spherical bead 32 welded to the machining area 26 to decrease to a predetermined temperature after stop of the laser oscillator 2. This continuation time has been determined based on conditions such as the material of the wire 5 and the size of the spherical bead 32, and is stored in advance in the control device 1. Then, after the predetermined continuation time has elapsed since the stop of the laser oscillator 2, the additive manufacturing apparatus 100 stops jetting the inert gas 25 from the gas nozzle 13 to the machining area 26. Thus, formation of one spherical bead 32 is completed.

In the fourth embodiment, the additive manufacturing apparatus 100 forms an inclination bead using the spherical bead 32, thereby allowing the inclination bead layer 351 not only to have a short width but also to have a small dimension in the depth direction (X-direction). The additive manufacturing apparatus 100 can thus form the inclined shaped object 500 having a bar shape extending in the Y-direction.

The additive manufacturing apparatus 100 is also capable of forming a three-dimensional shaped object having a complex shape such as a web-like structure by combining multiple inclined shaped objects 500 each having a bar shape. To this end, the additive manufacturing apparatus 100 forms the multiple inclined shaped objects 500 each having a bar shape to be aligned in parallel with the Y-axis direction. Thus, the additive manufacturing apparatus 100 forms three-dimensional shaped objects extending in the longitudinal direction, of the three-dimensional shaped objects that form a web-like structure. The additive manufacturing apparatus 100 further forms multiple shaped objects each having a bar shape to be aligned in parallel with the X-axis direction, over the multiple three-dimensional shaped objects extending in the longitudinal direction. Thus, the additive manufacturing apparatus 100 forms the shaped objects extending in the lateral direction, of the three-dimensional shaped objects that form a web-like structure. The additive manufacturing apparatus 100 forms three-dimensional shaped objects that form a web-like structure by combining these three-dimensional shaped objects extending in the longitudinal direction and these shaped objects extending in the lateral direction.

Thus, in the fourth embodiment, the additive manufacturing apparatus 100 forms a three-dimensional shaped object using the spherical bead 32. This enables the additive manufacturing apparatus 100 to produce a shaped object with a higher resolution of formation than when the unit bead is a linear bead, and to thus increase the formation precision.

The configurations described in the foregoing embodiments are merely examples. These configurations may be combined with a known other technology, and configurations of different embodiments may be combined together. Moreover, part of such configurations may be omitted and/or modified without departing from the spirit thereof.

### REFERENCE SIGNS LIST

1 control device; 2 laser oscillator; 3 fiber cable; 4 rotary motor; 5 wire; 6 wire spool; 7 gas supply device; 8 pipe; 10 machining head; 11 beam nozzle; 12 wire nozzle; 13 gas nozzle; 14 head drive unit; 15 stage; 16 rotation mechanism; 17 base substrate; 18 deposit; 19 wire supply unit; 21 molten wire; 22 additive target surface; 23 molten pool; 24 laser beam; 25 inert gas; 26 machining area; 31 upper base substrate; 32 spherical bead; 38 groove; 41 CPU; 42 RAM; 43 ROM; 44 external storage device; 45 input-output interface; 46 bus; 71 state observation unit; 72 learning unit; 100 additive manufacturing apparatus; 120 machine learning device; 101 bead; 201 base bead; 251 base bead layer; 310 intermediate inclination bead; 351 inclination bead layer; 400 base shaped object; 500-504, 510 inclined shaped object; A1 inclination angle; CL, CW central axis.

1. An additive manufacturing apparatus for forming an inclined shaped object on an additive target surface of a workpiece to which build material is to be added, the inclined shaped object being a shaped object inclined in an oblique direction oblique with respect to a vertical direction, the additive manufacturing apparatus comprising:
a material feeder to supply the build material to a machining area of the additive target surface;
an emitter to emit a laser beam to the machining area to melt the build material; and
control circuitry to control formation of the inclined shaped object by controlling the material feeder and the emitter, wherein
the control circuitry
causes a lower bead layer to be stacked, and then causes an upper bead layer to be stacked, the lower bead layer being a bead layer including a first bead and a second bead that are deposited, the upper bead layer being a bead layer including a third bead and a fourth bead that are deposited on a top surface of the lower bead layer, the upper bead layer being stacked by causing the third bead to be formed on the top surface of the lower bead layer, and then causing the fourth bead to be formed at a position where part of a bottom surface of the fourth bead has no contact with the lower bead layer, the fourth bead being in contact with the top surface of the lower bead layer and with a side surface of the third bead.

2. The additive manufacturing apparatus according to claim 1, wherein
the build material has a wire shape.

3. The additive manufacturing apparatus according to claim 1, wherein
the control circuitry causes a plurality of beads to be stacked on top of another to form the fourth bead.

4. The additive manufacturing apparatus according to claim 1, wherein
the control circuitry causes the third bead to have a width in an extending direction shorter than a width of the fourth bead in an extending direction.

5. The additive manufacturing apparatus according to claim 4, wherein
the control circuitry causes laser output power for forming the third bead to be lower than laser output power for forming the fourth bead.

6. The additive manufacturing apparatus according to claim 4, wherein
the control circuitry causes a scanning speed of the laser beam for forming the third bead to be higher than a scanning speed of the laser beam for forming the fourth bead.

7. The additive manufacturing apparatus according to claim 1, wherein
the control circuitry causes the third bead and the fourth bead to be formed using a ball-shaped bead.

8. An additive manufacturing method for forming an inclined shaped object on an additive target surface of a workpiece to which build material is to be added, the inclined shaped object being a shaped object inclined in an oblique direction oblique with respect to a vertical direction, the additive manufacturing method comprising:
supplying the build material to a machining area of the additive target surface; and
emitting a laser beam to the machining area to melt the build material, wherein
a lower bead layer is caused to be stacked, and then an upper bead layer is caused to be stacked, the lower bead layer being a bead layer including a first bead and a second bead that are deposited, the upper bead layer being a bead layer including a third bead and a fourth bead that are deposited on a top surface of the lower bead layer, the upper bead layer being stacked by causing the third bead to be formed on the top surface of the lower bead layer, and then causing the fourth bead to be formed at a position where part of a bottom surface of the fourth bead has no contact with the lower bead layer, the fourth bead being in contact with the top surface of the lower bead layer and with a side surface of the third bead.
